(19) United States
(12) Patent Application Publication
(10) Pub. No.: US 2002/0097461 A1
(43) Pub. Date: Jul. 25, 2002

(54) Bi-directional wavelength switched ring optical protection switching protocol

(76) Inventors: Naimish Patel, North Andover, MA (US); Paolo Narvaez, Cambridge, MA (US); Murat Azizoglu, North Billerica, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/899,341

(22) Filed: Jul. 5, 2001

Related U.S. Application Data
(60) Provisional application No. 60/216,991, filed on Jul. 7, 2000.

(51) Int. Cl. H04B 10/08; H04J 14/02

(52) U.S. Cl. 359/110; 359/124

(57) ABSTRACT

A system is provided for protecting a wavelength division multiplexing optical communications network against communication failures at the link, wavelength and fiber layers. The system includes failure detectors for detecting communication failures of the network and for generating failure signals in response thereto, and protection switching elements for receiving the failure signals and controlling the protection switching in response thereto. The system also includes a first set of intralayer communication channels within each of the link, wavelength and fiber layers for sending the failure signals between the failure detectors and the protection switching elements, and a second set of interlayer communication channels between adjacent ones of the link, wavelength and fiber layers for sending the failure signals between the failure detectors and the protection switching elements.

### CROSS REFERENCE TO RELATED APPLICATIONS

This application claims priority under 35 U.S.C. §119(e) to provisional patent application serial number 60/216,991 filed Jul. 7, 2000, the disclosure of which is hereby incorporated by reference.

### STATEMENT REGARDING FEDERALLY SPONSORED RESEARCH OR DEVELOPMENT

N/A

### BACKGROUND OF THE INVENTION

In optical communication networks, protection mechanisms are necessary for protecting against failures in communication paths. One example of such failures is a transponder failure where a particular wavelength becomes unavailable on one or more fibers while other wavelengths in the same fiber can still be used. In another type of failure where a fiber cut occurs, all of the wavelengths in a single fiber become unavailable and all of the fiber lightpaths must be rerouted on other fibers. A conduit cut is another example of a failure where all of the fibers following the same physical path become unavailable and the communication channel must be rerouted through a completely different physical lightpath. In the case of a node failure, an entire network element ceases to work, which is equivalent to multiple conduit failures on all segments connected to the failed node.

Various methods are known for restoring communication in the event of failures along a communication path by using equipment for detecting the failures and switching between different paths or resources. For instance, SONET has a known protection scheme for protecting against failures. The SONET protection scheme has a hierarchy for signaling among components at higher communication layers, namely the section, line and path layers. However, with the advent of Wavelength Division Multiplexing (WDM) networks, the protection schemes performed at the higher layers for SONET and other non-WDM transporting networks are insufficient for many telecommunication applications with respect to their speed and functionality. Accordingly, it is desirable to provide a protection mechanism that operates at lower layers, namely the link, wavelength and fiber layers, for use in WDM networks and in conjunction with the higher layers for improving the protection against failures.

### BRIEF SUMMARY OF THE INVENTION

A system is provided for protecting a wavelength division multiplexing optical communications network against communication failures at the link, wavelength and fiber layers. The system includes failure detectors for detecting communication failures of the network and for generating failure signals in response thereto, and protection switching elements for receiving the failure signals and controlling the protection switching in response thereto. The failure detectors and the protection switching elements are placed at predetermined positions in each of the link, wavelength and fiber layers.

The system also includes a first set of intralayer communication channels within each of the link, wavelength and fiber layers for sending the failure signals and the switching signals between the failure detectors and the protection switching elements in respective ones of the link, wavelength and fiber layers. A second set of interlayer communication channels are also included between adjacent ones of the link, wavelength and fiber layers for sending the failure signals and the switching signals between the failure detectors and the protection switching elements in adjacent ones of the link, wavelength and fiber layers. As a result, alternate communication paths may be developed in response to the failure signals and the switching signals when the communication failures are detected. By providing protection at the lower layers in the system of the present invention, WDM networks may be more completely protected against failures and may be used in conjunction with existing higher layer protection to provide enhanced network protection capabilities.

Other aspects, features and advantages of the present invention are disclosed in the detailed description that follows.

### BRIEF DESCRIPTION OF THE SEVERAL VIEWS OF THE DRAWING

The invention will be more fully understood by reference to the following detailed description of the invention in conjunction with the drawings, of which:

FIGS. 1(a), 1(b), and 1(c) illustrate network topologies to which protection switching may be applied according to the embodiments of the present invention;

FIG. 2 illustrates a control channel for communicating protection switching information in an embodiment of the present invention;

FIG. 3 illustrates upstream and downstream signaling of switching information according to an embodiment of the present invention;

FIG. 4 illustrates signal communication between layers according to an embodiment of the present invention; and

FIGS. 5(a) and 5(b) illustrate a system for sending and receiving signals according to an embodiment of the present invention.

### DETAILED DESCRIPTION OF THE INVENTION

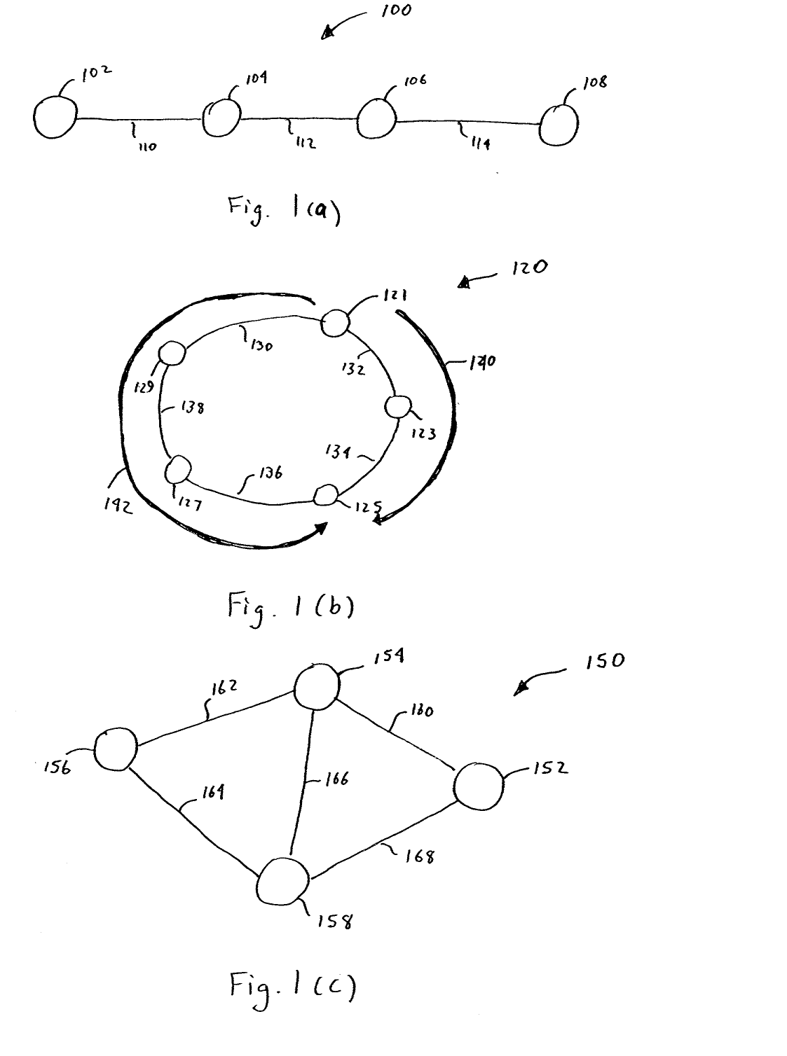

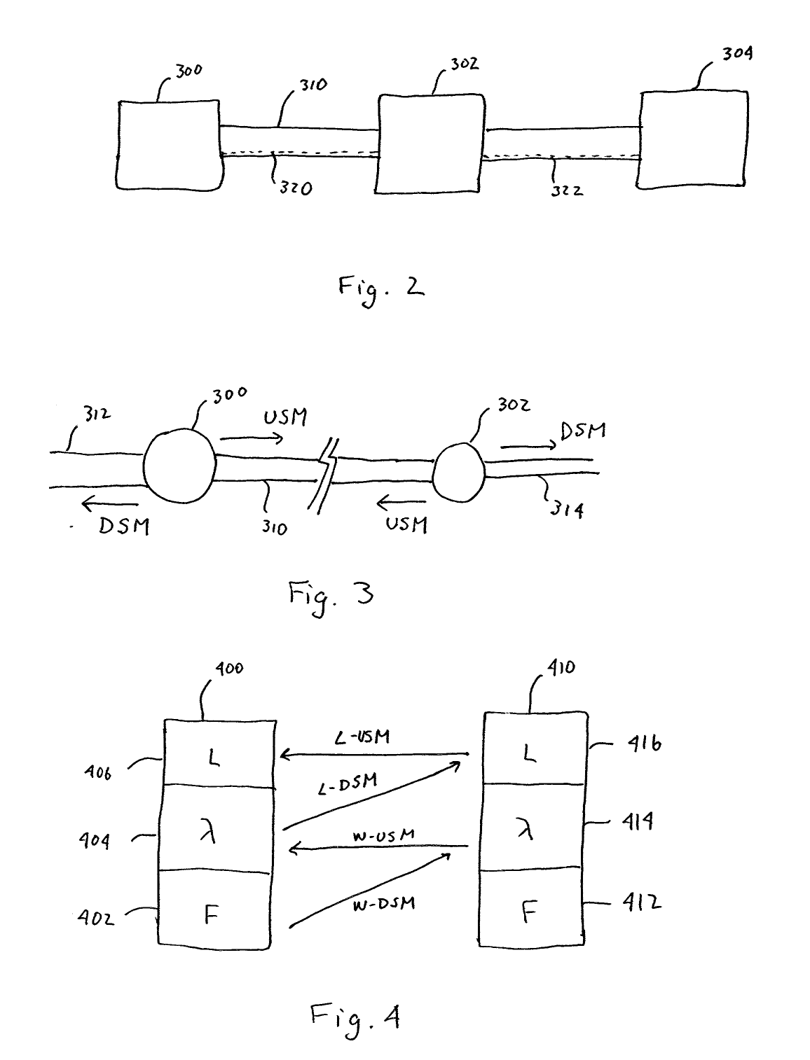

The protection system according to the embodiments of the present invention is applicable to various network topologies. FIGS. 1(a), 1(b), and 1(c) respectively illustrate three exemplary network topologies, linear, ring and mesh topologies, in which the present invention may be incorporated. In the linear topology 100 of FIG. 1(a), all the network elements or nodes 102, 104, 106 and 108 are placed along a single line. A first communication lightpath 110 is provided between nodes 102 and 104, a second communication lightpath 112 is provided between nodes 104 and 106, and a third communication lightpath 114 is provided between nodes 106 and 108. The terminal nodes 102 and 108 have a degree of one, while the other nodes 104 and 106 have a degree of two. Each of the first, second and third communication lightpaths 110, 112 and 114 are a single unique lightpath for connecting two of the nodes.

In linear topologies, communication channels between any two of the nodes must use the same lightpath. Because of the unique lightpaths used between the nodes, protection switching in linear topologies is accomplished by span switching. More particularly in span switching, the lightpath between two nodes are protected with redundant components (such as extra transponders, fibers, or conduits for example) in case one of these components fails. However, it is realized that in the event of a node failure, the network cannot be protected and the linear topology must be permanently split into two separate networks.

In the ring topology 120 of FIG. 1(b), nodes 121, 123, 125, 127, and 129 are organized around a loop and are respectively connected by communication lightpaths 130, 132, 134, 136, and 138 between each of the nodes. Each of the nodes has a degree of two. For every pair of nodes, there are two distinct communication paths through which data can be sent from one node to the other. One communication path may travel clockwise between the nodes on the ring, and the other communication path may travel counter-clockwise between the nodes on the ring. For instance, in communicating between nodes 121 and 125, a first communication path 140 may be formed in a clockwise direction using lightpaths 132 and 134, and a second communication path 142 may be formed in a counter-clockwise direction using lightpaths 130, 138 and 136.

Protection switching in ring networks typically uses route switching where one path between two nodes protects the path in the opposite direction between the nodes. In unidirectional rings, all working traffic takes one of these two directions and all protection traffic takes the other direction. In bi-directional rings, each working channel uses either of the two directions to forward its working traffic, and the protection traffic uses the other direction. However, span switching may also be used to protect ring networks.

In the mesh topology 150 of FIG. 1(c), nodes 152, 154, 156 and 158 are respectively connected by communication lightpaths 160, 162, 164, 166 and 168. Nodes of a mesh network may have a degree of more than two and are referred to as junction nodes. Junction nodes create a larger number of possible communication paths between two nodes. For instance, in FIG. 1(c), nodes 154 and 158 are junction nodes because they have a degree of three. In a mesh network, there are potentially many different communication paths between any two nodes. For path protection, two disjoint paths may be found for connecting a pair of nodes. As long as one lightpath is not essential for connecting nodes in the network connected, two disjoint working and protection paths may be assigned in mesh networks. Additionally, span switching may also be used in mesh networks.

A layering hierarchy is provided in an embodiment of the present invention for utilizing the functionality of the optical and electronic network components. The protection hierarchy reflects the layers of normal operation of a WDM network, specifically the link, wavelength and fiber layers. Each layer incorporates functional elements for detecting failures, communicating with other elements about the detected failures and performing protection switching. The fiber layer, which is the bottom-most layer of the present layering hierarchy, includes all of the components at the endpoints of every lightpath such as optical amplifiers and terminal nodes. The next layer of the present hierarchy is the wavelength layer which includes elements for processing individual wavelengths such as equalizers and optical cross-connects that can optically select a single wavelength. The link layer follows next in this hierarchy and includes elements for electronically terminating an optical signal.

More particularly, the fiber layer may use an optical supervisory channel (OSC) for communicating protection information. The OSC may be included in the fiber layer as a single extra wavelength within each lightpath as illustrated in FIG. 2. Nodes 300, 302, and 304 are connected by lightpaths 310 and 312. OSCs 320 and 322 are included within each of the lightpaths 310 and 312 for controlling the fiber layer. The OSC is often used for topology discovery, network management, and setting up the initial working and protect channels. The OSC is adequate for these functions because every element in the network is connected and speed is not critical for these applications. Before any connections are made, the fiber topology is the only existing topology. Higher layer connections (such as wavelength and circuit layer connections) can then be established to provide bandwidth service. Thereafter, protection bandwidth can be allocated and the protection schemes prepared through the fiber layer.

Because there are many components in the fiber layer, it may be impractical to use the OSC as a communication channel to achieve rapid protection switching. Even though messages for any purpose may be routed through the OSC, the routing complexity involved is too large for cases where speed is critical. Communication through the OSC requires traveling through many connections, deciding which lightpath a message should follow and using multiple layers of network protocols (such as TCP/IP). All of these requirements contribute to the increasing the complexity and decreasing the speed of the OSC. In most cases, higher layer communication channels are preferred for protection switching purposes because the affected components may be directly connected and the high layers contain less overhead.

Heretofore, an adequate communication channel for the wavelength layer has not existed. Although it would be possible to use the OSC for protection signaling at this layer, it would require a much more complex protocol than is presently available. However, an arrangement is presented below that can be used to provide wavelength layer communications.

In the link layer, communication between the elements may be performed by utilizing extra bytes from an in-band forward error correcting (FEC) channel.

From a service perspective, the link layer provides an end-to-end link for customer “circuits,” such as SONET STS-n signals. In the case of SONET circuits, circuit-layer protection mechanisms may be available in addition to WDM-layer mechanisms. Header bits in SONET frames may be used to communicate between the elements in the circuit layer. However, these header bits are not always available to the WDM protection equipment, and under some service types, the incoming SONET headers cannot be changed. As a result, the circuit layer is without adequate communication channels in these instances. Because the type of control channel available for a circuit is not necessarily known, protection switching at the circuit layer cannot be relied upon. Therefore, protection switching at lower layers (link, wavelength and fiber layers) is desired. Accordingly, systems and methods for protection switching in these lower levels are provided in the embodiments of the present invention.

In contrast to routing restoration, protection switching is pre-planned and must be performed extremely fast. To ensure speed and simplicity, it is highly desirable to perform protection switching at the most local level possible, or at least at the initial stages after a failure. After the initial protection switching, additional protection switching schemes may be performed.

The protection switching according to the embodiments of the present invention is directed to detecting communication failures and initiating protection switching with a local interaction or at the most local level possible. A local interaction is one that involves network elements that are physically close to each other and that communicate using low-level network layers. For example, the most local interaction is that of two fiber-layer elements on opposite sides of the same fiber. By either increasing the distance between the elements or using higher layer protocols, the interaction becomes less local. If the protection is inadequate or more efficient routing is needed, protection at a higher networking layer or at a larger geographic area may be triggered. Performing protection at a larger geographic area is most useful in mesh topologies. When performing protection at the highest level layers, protection blends into routing restoration.

The protection system according to the embodiments of the present invention ensures that several network layers have the capability of performing protection switching. Lower layers are able to perform protection switching faster, but with less efficiency. Therefore, higher layers are utilized to perform protection switching when lower layers fail, or when greater efficiency is needed. When the higher layers are needed for greater efficiency, protection switching can be performed any time after the lower layers have initially protected the affected channels.

In the embodiments of the present invention, protection switching is accomplished by detecting the occurrence of communication failures and generating, sending and receiving signals at different level layers of the network. To detect communication failures in network layers, a plurality of failure detectors are placed at predetermined positions in each of the desired layers. In the present embodiment, the failure detectors are positioned in the link, wavelength and fiber layers for actively performing failure detection. When one of the failure detectors detects a communication failure, a failure alarm signal is generated in response. These failure alarm signals may be sent both within the respective layer on intralayer communication channels and between adjacent layers on interlayer communication channels. For instance, failure detectors at the receiving end of the fiber and wavelength layers may be used to detect communication failures and generate the failure alarm signal. The failure detectors at the link layer may generate the failure alarm signal in response to detecting a loss of signal (LOS) or a loss of frame (LOF) event. The LOS and LOF events are the same as defined in the SONET specifications because both the link and circuit layers are manipulating SONET frames.

When one of the failure detectors at the receiving end at a layers detects a communication failure, an Upstream Signaling Message (USM) signal is generated and sent to a peer using an upstream channel. As illustrated in FIG. 3 for example, if a channel 310 carrying data from node 300 to node 302 fails, node 302 sends a USM signal using a return channel back to node 300. To transmit the USM signals, each layer uses its own communication channel as the return channel. The form of the signaling message varies depending on the layer. For example, at the link layer, a message takes the form of a series of bytes in the FEC channel. As described in more detail below, messages at the wavelength layer take the form of a pattern of modulation of an optical carrier.

In the following description, to distinguish between the USM signals on each layer, the following convention is used: the F-USM signal is used at the fiber layer; the W-USM signal is used at the wavelength layer; the L-USM signal is used at the link layer; and the C-USM signal is used at the circuit layer.

In addition to the upstream signaling, a downstream signaling message (DSM) signal is sent to the adjacent higher layer over an intralayer communication channel for initiating protection. More specifically, a W-DSM signal is used by the fiber layer to alert the wavelength layer of a communication failure; an L-DSM signal is used by the wavelength layer to alert the link layer of a failure, and a C-DSM signal is used by the link layer to alert the circuit layer of a failure. In contrast to the USM signal, the DSM signal travels in a downstream direction of the failure. For instance, if a communication failure occurs between node 300 and node 302, a DSM signal is generated at node 302 and travels downstream away from node 300 on channel 314. As generally shown in FIG. 3, if the channel 310 between nodes 300 and 302 fails, both of the failure detectors at nodes 300 and 302 detect the failure and each node sends a USM signal upstream for signaling the failure along a return channel of channel 310. If further protection is to be performed at higher layers, DSM signals are sent in the downstream direction along channels 312 and 314.

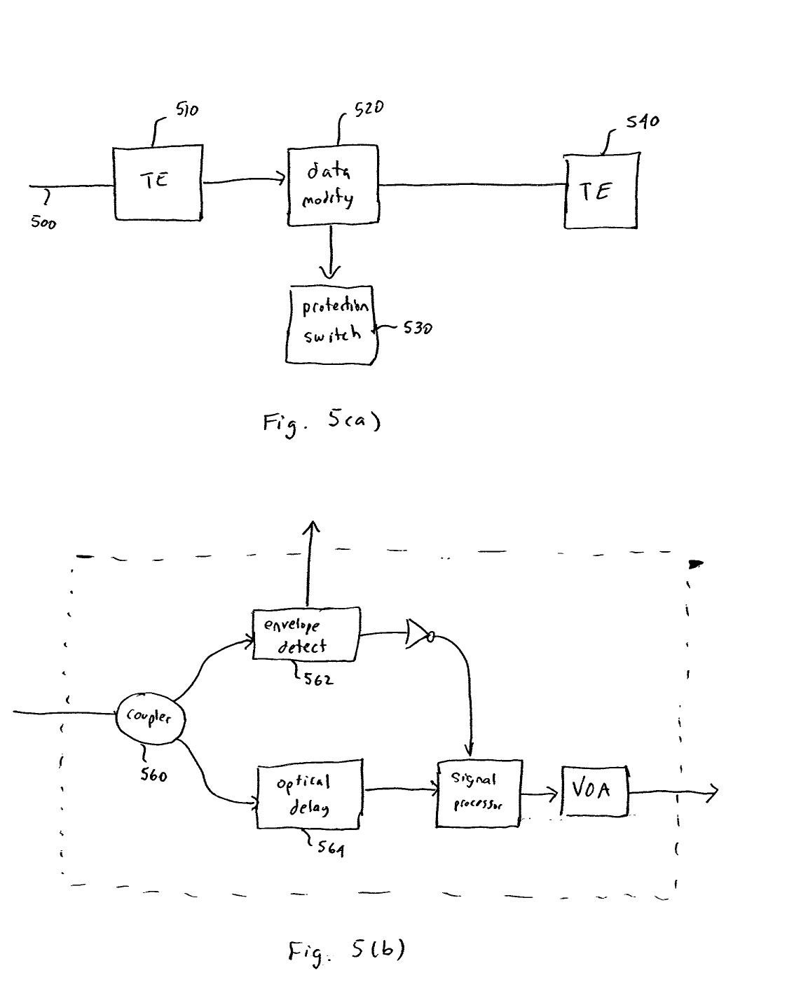

Protection is initiated in response to the USM signal by protection switching elements in the respective layers that control the protection traffic and paths. Additionally, if the protection is inadequate or more efficient routing is desired, further actions may be taken at a node receiving a DSM signal. FIG. 4 illustrates an example of the upstream and downstream signaling between layers. Link-layer elements 406 and 416, wavelength-layer elements 404 and 414, and fiber-layer elements 402 and 412 for nodes 400 and 410, respectively, are provided for sending and receiving these signals. In this example, an L-USM signal travels upstream between the link elements 416 and 406, and a W-USM signal travels upstream between the wavelength elements 414 and 404 along respective intralayer communication channels. Also, an L-DSM signal travels downstream from the wavelength element 404 to the link layer 416 and a W-DSM signal travels downstream from the fiber element 402 to the wavelength element 414 are shown for communicating between interlayer communication channels.

When a failure is detected, two types of protection switching may be performed. One type of protection is span switching where the data traffic is sent along another resource (such as a different wavelength or fiber) of the same physical path. The other type of protection is route switching where the data traffic is sent along different resources and a different physical path. While route-switching protection can generally be used for any failure (assuming intact protection routes exist), span switching will only work if the failure is small enough. For example, at the fiber layer, span switching is only possible for transponder failures or fiber cuts. At the wavelength and link layers, span switching is only effective against transponder failures. In contrast, route switching is effective for failures at all layers.

The controlling performed by the protection switching elements at the link layer will be described in one example of the present invention with reference to FIG. 3. At the link layer, an optical termination device 300 is used for reading and writing data to and from the FEC channel 310 and communicating with the optical termination 302 on the other side of the FEC channel 310. When one of the termination devices for an Optical Terminal Regeneration Node (OTRN) or an Optical Add Drop Node (OADN) receives an LOS or LOF signal, communication from a peer to its termination device has been interrupted as a result of a failure along the lightpath. After detecting a failure, the protection switching element sends an L-USM signal to its peer node using the in-band FEC channel. If the failure involves more than one fiber (a conduit cut or a node failure for example), the upstream node may not receive the L-USM signal. However, the failure detector at this node will also be detecting a link failure.

If a node receives an L-USM signal, but does not detect a failure, then its peer node on the other side of the lightpath is not receiving the data being transmitted. If the node detects a failure, then the node will not receive an L-USM signal because the communication between a peer and its node has been interrupted. However, it cannot be ascertained whether communication between the node and its peer node has also been interrupted. After a node detects a failure or receives an L-USM signal, the protection switching element at the node identifies a lightpath that needs to be protected. If only one lightpath failure is detected, a transponder failure only will have occurred which does not require route protection switching. The protection switching element that receives the L-USM signal performs span switching by switching to another available wavelength. This protection switching will be accomplished if an ordered set of extra wavelengths that can be used for span switching are preassigned for both optical termination endpoints.

On the other hand, if more than one lightpath failure is detected, a fiber cut, a conduit cut, or a node failure will have occurred and route switching must be performed to maintain communication. Accordingly, the outgoing lightpath is switched to its protect wavelength and the incoming lightpath is switched to its protect wavelength. Because the data traffic travels in a bi-directional working lightpath on one wavelength, the direction is transferred to a set of protect lightpaths on another wavelength and in another direction. The protection switching elements according to the present embodiment restores all of the circuits after the occurrence of a communication failure.

In cases where some of the circuits are not terminated at the same point as the link carrying them, it is desirable to have a more complex mechanism to extend protection to the circuit layer. Circuit switching may be necessary in cases where link protection fails to operate correctly. When a link-layer failure detector or protection switching element at a node detects a failure or receives an L-USM signal, it is first determined how many of the circuits do not terminate at that node. If all circuits do terminate at that node, link switching is directly performed at that node.

However, if some circuits do not terminate at that node, the node may perform circuit switching. For any of these non-terminating circuits, the protection switching element at that node can send a C-DSM signal downstream. The protection switching element in the link layer that originally detects a communication failure sends a C-DSM signal by invalidating all the first and second bytes of header in the SONET line of all the circuits in the affected link. Accordingly, a loss of pointer (LOP) signal is generated by a protection switching element at the termination of the circuit. A failure can also be detected at the circuit layer independently of the link layer but is only generated after the link layer has failed to protect the circuit because protection at the circuit layer is a slower protection mechanism.

When protection switching element at the circuit layer detects a communication failure (either by itself or responsive to a C-DSM signal), a C-USM signal is sent to its peer. The C-USM signal is sent over the K1/K2 bytes in the SONET line overhead. If the failure involves only a transponder or a single fiber, the other circuit termination device receives the C-USM signal, which will determine the protection switching to be performed for that circuit.

When the circuit terminating node detects a failure, receives a C-USM signal, or a C-DSM signal, circuit protection switching is initiated for that circuit only. After the detection, the terminating node will de-multiplex the affected circuit from the protection lightpath, rather than from the working lightpath. Likewise, the return circuit is multiplexed into the protect lightpath. In a preferred embodiment, the working and protection wavelengths are paired and dropped at the same nodes, and therefore protection switching is possible for every circuit.

Link switching and circuit switching can be performed at the same time and may operate interchangeably. For example, on one side of a conduit cut, the closest electrical node can perform link protection, while on the other side of the cut, the closest electrical node can send a C-USM signal upstream to initiate circuit switching for each individual circuit. Also, a single node may perform both link protection and circuit protection. A particular circuit is protected as long as either circuit protection is performed, link protection is performed on the carrier link for the circuit, or if both circuit and link protection are performed.

Generally, protection switching at the circuit layer can only be performed if the service offered to the outside networks is not a transparent physical service. When transparent services are provided, WDM network elements cannot write into the section or line overhead bytes, and therefore another communication channel is necessary for performing circuit protection switching. In one embodiment for performing such protection switching, the link performs link protection whenever any of the affected circuits is providing transparent service, so that it is not necessary to perform circuit protection for these circuits. There can be many other ways in which these layers can interoperate. It is desirable to control communication of predetermined failures at the higher layers and integrate these higher layers into the present protection switching scheme.

For sending and receiving signals at the wavelength layer in the protection scheme in an embodiment of the present invention, a system for modulating signals over a communication channel is illustrated in FIG. 5(a). A terminating element 510 receives an optical signal from an optical fiber 500. The optical signal contains high-rate modulation for data traffic and a lower-rate modulation carrying the protection communication channel. If a communication failure is detected, protection control signaling, such as a USM signal, is sent upstream. A data modifying element 520 connected to the terminating element 510 detects the low-rate modulation and directs the information to a protection switching element 530. Any control protection signaling in the data is read by the protection switching element 530 for protection control in response thereto. Next, the data modifying element 520 erases the control protection signaling from the optical signal so that the optical signal output from the data modifying element 520 to the next terminating element 540 can be re-modulated with new control protection signaling information.

FIG. 5(b) is a more detailed illustration of the data modifying element 520 used in the system of the present embodiment. The data is input to the data modifying element 520 at a tap coupler 560. The coupler 560 directs a small portion of the signal to a slow envelope detector 562 and a larger portion of the signal to an optical delay device 564. The envelope detector 562 sends the detected signal to the protection switching element 530 and an inverter 566. The larger portion of the data is delayed by the optical delay device 564 so that a signal processor 568 may combine the delayed data with signal from the inverter 566. Thereafter, a variable optical attenuator 570 outputs the data after having erased the protection control signaling that was initially received.

It will be apparent to those skilled in the art that other modifications to and variations of the above-described techniques are possible without departing from the inventive concepts disclosed herein. Accordingly, the invention should be viewed as limited solely by the scope and spirit of the appended claims.

What is claimed is:

1. A system for protecting a wavelength division multiplexing optical communications network operating at the link, wavelength and fiber layers, comprising:
a plurality of failure detectors at predetermined positions in each of the link, wavelength and fiber layers for detecting communication failures of paths in the network and generating failure signals in response thereto;
a plurality of protection switching elements at predetermined network connections in each of the link, wavelength and fiber layers for receiving said failure signals and controlling the protection switching in response thereto;
a first set of intralayer communication channels within each of said link, wavelength and fiber layers for sending said failure signals between said failure detectors and said protection switching elements in respective ones of said link, wavelength and fiber layers; and
a second set of interlayer communication channels between adjacent ones of said link, wavelength and fiber layers for sending said failure signals between said failure detectors and said protection switching elements in adjacent ones of said link, wavelength and fiber layers so that alternate communication paths may be developed in response to said failure signals and said switching signals when the communication failures are detected.
